(19) United States
(12) Patent Application Publication
(10) Pub. No.: US 2025/0059361 A1
(43) Pub. Date: Feb. 20, 2025

(54) OLEFIN-BASED INTERPOLYMERS AND TACKIFIER COMPOSITIONS

(71) Applicant: Dow Global Technologies LLC, Midland, MI (US)

(72) Inventors: Yunfeng Yang, Shanghai (CN); Xuejun Liu, Shanghai (CN); Colin Li Pi Shan, Pearland, TX (US); Wanfu Ma, Shanghai (CN)

(21) Appl. No.: 18/721,429

(22) PCT Filed: Dec. 20, 2021
(86) PCT No.: PCT/CN2021/139510

§ 371 Date: Jun. 18, 2024

(51) Int. Cl. C08L 23/08; C08L 53/00; D06N 3/04; D06N 3/10

(52) U.S. Cl. CPC C08L 23/0815; C08L 53/00; D06N 3/045; D06N 3/106; C08L 2205/03; D06N 2203/042

(57) ABSTRACT

A composition comprising at least the following components: a) at least one olefin-based interpolymer that comprises the following properties: i) a melt index (I2)≤30 dg/min or a melt flow rate (MFR)≤30 dg/min, b) a tackifier; and wherein the composition has a melt index (I2)≤10 g/10 min.

### BACKGROUND OF THE INVENTION

Polyolefin elastomer (POE-based) artificial leather (AL) is thought to be an eco-friendly and sustainable leather product. Compared with incumbent polyvinylchloride (PVC) leather, POE-based leather is halogen free and also free of phthalate-like plasticizers. Compared with other incumbent polyurethane (PU) leather, no solvent (for example, DMF (harmful)) is needed during the POE-based leather manufacturing process. Thus, POE-based leather production is greener, which brings minimal water/air/soil pollution. Although PU and solvent-free PU are becoming widely used, POE-based leather still has the advantage of easy recyclability, due to its thermoplastic nature. From the point of view of performance, POE has excellent weatherability and low temperature flexibility, and no hydrolysis and yellowing issues. Also, POE-based leather can more easily meet the lightweight trend in luggage/bag, shoe and auto applications, because POE density is much lower than PVC (by approx. 40%) and lower than PU (by approx. 25%). POE-based leather will be a promising product to replace PVC and PU leather in several applications. Thus, there is a need for compositions that can be used as POE-based leather compositions. There is a further need for such compositions that have excellent performance properties suitable for good leather products.

U.S. Publication 2012/0108134 discloses a multilayer structure comprising the following: A) a top skin layer comprising a propylene/alpha-olefin copolymer and at least one of the following: (i) a styrenic block copolymer, (ii) a homogeneously branched ethylene/alpha-olefin copolymer, (iii) an olefin block copolymer, and (iv) a random polypropylene copolymer; B) a middle foam layer comprising a propylene/alpha olefin copolymer and at least one of the following: (i) a styrenic block copolymer, (ii) a homogeneously branched ethylene/alpha-olefin copolymer, (iii) an olefin block copolymer, and (iv) a random polypropylene copolymer; and C) a bottom fabric layer comprising a nonwoven, polymeric spunbound material (see, for example, claim 1). The top skin layer and the middle layer may comprise at least one of an antioxidant, curing agent, cross linking coagent, booster and retardant, processing aid, filler, ultraviolet absorber or stabilizer, antistatic agent, nucleating agent, slip agent, plasticizer, lubricant, viscosity control agent, tackifier, anti-blocking agent, surfactant, extender oil, acid scavenger, and metal deactivator (see for example, claim 9).

U.S. Pat. No. 7,199,180 discloses adhesive compositions comprising at least one homogeneous ethylene/alpha-olefin interpolymer and a tackifier. This reference discloses, in general, several types of tackifiers (see column 15, lines 43-49; column 46, lines 14-18), and adhesive compositions containing tackifiers (see for example, Tables 9, 12-21).

U.S. Pat. No. 6,582,829 discloses a hot melt adhesive composition comprising: a) from about 5 wt % to about 50 wt % of at least one homogeneous linear or substantially linear ethylene/alpha-olefin interpolymer, characterized as having a density from 0.850 to 0.965 g/cm; b) from about 1 wt % to about 40 wt % of at least one block copolymer; and c) from about 10 wt % to about 75 wt % of at least one tackifying resin (see abstract). This reference discloses, in general, several types of tackifiers (see column 7, line 64, to column 8, line 17).

U.S. Pat. No. 9,115,299 discloses a low application temperature, hot melt adhesive comprising olefin copolymers with an average melt index greater than 5, but less than about 35 g/10 minutes, at 190° C. The adhesive is disclosed as useful in construction of nonwoven articles (see abstract). This reference discloses, in general, several types of tackifiers (see column 6, lines 26-67).

Additional compositions are disclosed in the following references: U.S. Pat. No. 6,319,979; U.S. Publication 2014/0037876; International Publications WO2015/013472, WO2017/102720, WO2018/176250 and WO2019/037039.

However, as discussed above, there remains a need for compositions that can be used as POE-based leather compositions, and that have that have excellent performance properties suitable for good leather products. These needs have met by the following invention.

### SUMMARY OF THE INVENTION

A composition comprising at least the following components:
a) at least one olefin-based interpolymer that comprises the following properties:
   i) a melt index (I2)≤30 dg/min or a melt flow rate (MFR)≤30 dg/min,
b) a tackifier; and
   wherein the composition has a melt index (I2)≤10 g/10 min.

### BRIEF DESCRIPTION OF THE DRAWINGS

FIG. 1 depicts the DMS profiles for inventive compositions IE2, IE4 and IE5.

### DETAILED DESCRIPTION OF THE INVENTION

Compositions have been discovered that have high bally flex resistance, softness and flowability. Bally flex resistance is a critical performance of leather products, and is a characterization of durability and mechanical fatigue during a cyclic flexural stress. In general, POE is not as good as PU and PVC in terms of bally flex resistance. Another critical requirement for leather is hand-feel, which is strongly determined by material softness (or flexural modulus), since high softness is usually required for most leather application.

Typically, the POE flex resistance can be improved by appropriately increasing resin density and decreasing MI (for example, high molecular weight). However, the high resin density makes the leather hard and deteriorates a soft “hand-feel.” Increasing the molecular weight results in low flowability, making processing difficult (for example, calendaring and extrusion casting). High flowability is required for smoothness and high processing efficiency. It is difficult to achieve good flex resistance, softness and flowability of POE resins at the same time. However, as discussed above, compositions have been discovered that have high bally flex resistance, softness and flowability.

As discussed above, a composition is provided which comprises at least the following components:
a) at least one olefin-based interpolymer that comprises the following properties:
   i) a melt index (I2)≤30 dg/min or a melt flow rate (MFR)≤30 dg/min,
b) a tackifier; and wherein the composition has a melt index (I2)≤10 g/10 min.

The above composition may comprise a combination of two or more embodiments, as described herein. Each component of the composition may comprise a combination of two or more embodiments, as described herein.

In one embodiment, or a combination of two or more embodiments, each described herein, the composition has a “Bally Flex Failure Cycles” value ≥90 k, or ≥95 k, or ≥100 k, or ≥100 k.

In one embodiment, or a combination of two or more embodiments, each described herein, the composition has a melt index (I2)≥1.0, or ≥1.5, or ≥2.0, or ≥2.5, or ≥3.0, or ≥3.5, or ≥4.0 g/10 min. In one embodiment, or a combination of two or more embodiments, each described herein, the composition has a melt index (I2)≤9.5, or ≤9.0, or ≤8.5, or ≤8.0, or ≤7.8, or ≤7.6, or ≤7.4 dg/min.

In one embodiment, or a combination of two or more embodiments, each described herein, the composition comprises ≥5.0 wt %, or ≥7.0 wt %, or ≥8.0 wt %, or ≥10 wt %, or ≥12 wt %, or ≥14 wt %, or ≥16 wt % or ≥18 wt %, or ≥20 wt % of component b, based on the weight of the composition. In one embodiment, or a combination of two or more embodiments, each described herein, the composition comprises ≤75 wt %, or ≤70 wt %, or ≤65 wt %, or ≤60 wt %, or ≤55 wt %, or ≤50 wt %, or ≤45 wt %, or ≤40 wt %, or ≤38 wt %, or ≤36 wt %, or ≤34 wt %, or ≤32 wt %, or ≤30 wt % of component b, based on the weight of the composition.

In one embodiment, or a combination of two or more embodiments, each described herein, component a is at least one ethylene-based interpolymer.

In one embodiment, or a combination of two or more embodiments, each described herein, the ethylene-based interpolymer (of component a) has a melt index (I2)≥0.2, or ≥0.4, or ≥0.6, or ≥0.8, or ≥0.9, or ≥1.0 g/10 min. In one embodiment, or a combination of two or more embodiments, each described herein, the ethylene-based interpolymer (of component a) has a melt index (I2)≤28, or ≤26, or ≤24, or ≤22, or ≤20, or ≤18, or ≤16 g/10 min.

In one embodiment, or a combination of two or more embodiments, each described herein, the ethylene-based interpolymer (of component a) has a density ≥0.856 g/cc, or ≥0.858 g/cc, or ≥0.860 g/cc, or ≥0.862 g/cc, or ≥0.863 g/cc, or ≥0.864 g/cc, or ≥0.866 g/cc, or ≥0.868 g/cc, or ≥0.870 g/cc (1 cc=1 cm³). In one embodiment, or a combination of two or more embodiments, each described herein, the ethylene-based interpolymer (of component a) has a density ≤0.900 g/cc, or ≤0.895 g/cc, or ≤0.890 g/cc, or ≤0.888 g/cc, or ≤0.887 g/cc, or ≤0.886 g/cc, or ≤0.884 g/cc, or ≤0.882 g/cc, or ≤0.880 g/cc.

In one embodiment, or a combination of two or more embodiments, each described herein, the ethylene-based interpolymer (of component a) is an ethylene/alpha-olefin interpolymer. In one embodiment, or a combination of two or more embodiments, each described herein, the ethylene/alpha-olefin interpolymer (of component a) is an ethylene/alpha-olefin copolymer.

In one embodiment, or a combination of two or more embodiments, each described herein, the ethylene-based interpolymer (of component a) is an ethylene/alpha-olefin multiblock interpolymer. In one embodiment, or a combination of two or more embodiments, each described herein, the ethylene/alpha-olefin multiblock interpolymer (of component a) is an ethylene/alpha-olefin multiblock copolymer.

In one embodiment, or a combination of two or more embodiments, each described herein, component a is an ethylene/alpha-olefin interpolymer and an ethylene/alpha-olefin multiblock interpolymer. In one embodiment, or a combination of two or more embodiments, each described herein, the ethylene/alpha-olefin multiblock interpolymer is an ethylene/alpha-olefin multiblock copolymer. In one embodiment, or a combination of two or more embodiments, each described herein, the ethylene/alpha-olefin interpolymer is an ethylene/alpha-olefin copolymer.

In one embodiment, or a combination of two or more embodiments, each described herein, the weight ratio of the ethylene/alpha-olefin interpolymer to the ethylene/alpha-olefin multiblock interpolymer is ≥0.08, or ≥0.85, or ≥0.90, or ≥0.95, or ≥1.0. In one embodiment, or a combination of two or more embodiments, each described herein, the weight ratio of the ethylene/alpha-olefin interpolymer to the ethylene/alpha-olefin multiblock interpolymer is ≤3.0, or ≤2.8, or ≤2.6, or ≤2.4, or ≤2.2, or ≤2.0, or ≤1.8, or ≤1.6, or ≤1.4, or ≤1.2, or ≤1.1.

In one embodiment, or a combination of two or more embodiments, each described herein, the tackifier (component b) is selected from a hydrogenated aliphatic resin, a cycloaliphatic hydrocarbon resin, an aliphatic C5 resin, an aromatic modified aliphatic C5 tackifier, or any combination thereof.

In one embodiment, or a combination of two or more embodiments, each described herein, the composition comprises ≥60 wt %, ≥70 wt %, or ≥80 wt %, or ≥85 wt %, or ≥90 wt %, or ≥92 wt %, or ≥94 wt %, or ≥96 wt % of the sum of components a and b, based on the weight of the composition. In one embodiment, or a combination of two or more embodiments, each described herein, the composition comprises ≤100 wt %, or ≤99 wt %, ≤98 wt %, or ≤97 wt % of the sum of components a and b, based on the weight of the composition.

In one embodiment, or a combination of two or more embodiments, each described herein, the composition further comprises at least one filler (component c).

Also provided is an article formed from the composition of an embodiment or a combination of two or more embodiments described herein. In a further embodiment, the article is artificial leather.

Also provided is a method of forming artificial leather, said method comprising mixing the composition of an embodiment or a combination of two or more embodiments described herein.

### Olefin-based Interpolymers

Olefin-based interpolymers include ethylene-based interpolymers and propylene-based interpolymers. Ethylene-based interpolymers include ethylene/alpha-olefin interpolymers and ethylene/alpha-olefin multi-block interpolymers.

The ethylene/alpha-olefin interpolymers and copolymers comprises, in polymerize form, ethylene, and an alpha-olefin. Alpha-olefins include, but are not limited to, a C3-C20 alpha-olefins, further C3-C10 alpha-olefins, further C3-C8 alpha-olefins, such as propylene, 1-butene, 1-hexene, and 1-octene. Such interpolymers also include ethylene/alpha-olefin/nonconjugated polyene interpolymers, which comprise, in polymerize form, ethylene, an alpha-olefin, and a nonconjugated polyene. Alpha-olefins include, but are not limited to, a C3-C20 alpha-olefins, further C3-C10 alpha-olefins, further C3-C8 alpha-olefins. In one embodiment, the interpolymer is an ethylene/propylene/nonconjugated polyene interpolymer, further a terpolymer, further an EPDM. Suitable examples of nonconjugated polyenes include the C4-C40 nonconjugated dienes. Nonconjugated dienes include, but are not limited to, 5-ethylidene-2-norbornene (ENB), 5-vinyl-2-norbornene (VNB), dicyclopentadiene, 1,4-hexadiene, or 7-methyl-1,6-octadiene, and further from ENB, VNB, dicyclopentadiene or 1,4-hexadiene, and further from ENB or VNB, and further ENB.

Ethylene/alpha-olefin multi-block interpolymers are characterized by multiple blocks or segments of two or more polymerized monomer units, differing in chemical or physical properties. In some embodiments, the multi-block copolymers can be represented by the following formula: (AB)ₙ, where n is at least 1, preferably an integer greater than 1, such as 2, 3, 4, 5, 10, 15, 20, 30, 40, 50, 60, 70, 80, 90, 100, or higher. Here, “A” represents a hard block or segment, and “B” represents a soft block or segment. Preferably the A segments and the B segments are linked in a substantially linear fashion, as opposed to a substantially branched or substantially star-shaped fashion. In other embodiments, the A segments and the B segments are randomly distributed along the polymer chain. In other words, for example, the block copolymers usually do not have a structure as follows: AAA-AA-BBB-BB. In still other embodiments, the block copolymers do not usually have a third type of block or segment, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

The term “hard segments (HS),” as used herein, refer to blocks of polymerized monomer units, in which ethylene is present in an amount ≥92 mol %, or ≥95 mol %, or ≥98 mol %, or ≥99 mol %, based on the total number of moles of polymerized monomers in the blocks. In one embodiment, ethylene is present in an amount ≤99.8 mol %, or ≤99.6 mol %, or ≤99.4 mol %, or ≤99.3 mol %, based on the total number of moles of polymerized monomers in the blocks.

The term “soft segments (SS),” as used herein, refer to blocks of polymerized monomer units, in which ethylene is present in an amount ≤90 mol %, or ≤88 mol %, or ≤86 mol %, or ≤84 mol %, based on the total number of moles of polymerized monomers in the blocks. In one embodiment, ethylene is present in an amount ≥80 mol %, or ≥81 mol %, or ≥82 mol %, based on the total number of moles of polymerized monomers in the blocks.

Typically, ethylene comprises 50 mole percent or a majority mole percent of the whole multi-block copolymer; that is, ethylene comprises at least 50 mole percent of the whole polymer. More preferably ethylene comprises at least 60 mole percent, at least 70 mole percent, or at least 80 mole percent, with the substantial remainder of the whole polymer comprising at least one other comonomer that is preferably an alpha-olefin having three or more carbon atoms.

As discussed, the ethylene/alpha-olefin multi-block interpolymers comprise two or more chemically distinct regions or segments (referred to as “blocks”), preferably joined in a linear manner. In an embodiment, the blocks differ in the amount or type of incorporated comonomer, density, amount of crystallinity, crystallite size attributable to a polymer of such composition, type or degree of tacticity (isotactic or syndiotactic), region-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present ethylene/alpha-olefin multi-block interpolymer is characterized by unique distributions of both polymer polydispersity (PDI or Mw/Mn or MWD), block length distribution, and/or block number distribution, due, in an embodiment, to the effect of the shuttling agent(s) in combination with multiple catalysts used in their preparation.

The olefin multiblock copolymers, in general, are produced via a chain shuttling process, such as, for example, described in U.S. Pat. No. 7,858,706, which is herein incorporated by reference. Some chain shuttling agents and related information are listed in Col. 16, line 39, through Col. 19, line 44. Some catalysts are described in Col. 19, line 45, through Col. 46, line 19, and some co-catalysts in Col. 46, line 20, through Col. 51 line 28. Some process features are described in Col 51, line 29, through Col. 54, line 56. See also the following: U.S. Pat. Nos. 7,608,668; 7,893,166; and 7,947,793 as well as US Patent Publication 2010/0197880. See also U.S. Pat. No. 9,243,173.

Propylene-based interpolymers include propylene/ethylene interpolymers and copolymers, and propylene/alpha-olefin interpolymers and copolymers. Alpha-olefins include, but are not limited to, a C4-C20 alpha-olefins, further C4-C10 alpha-olefins, further C4-C8 alpha-olefins, such as 1-butene, 1-hexene, and 1-octene.

Tackifiers Tackifiers are known in the art, and may be solids, semi-solids, or liquids at room temperature. Non limiting examples of tackifiers include (1) natural and modified rosins (for example, gum rosin, wood rosin, tall oil rosin, distilled rosin, hydrogenated rosin, dimerized rosin, and polymerized rosin); (2) glycerol and pentaerythritol esters of natural and modified rosins (for example, the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin); (3) copolymers and terpolymers of natured terpenes (for example, styrene/terpene and alpha methyl styrene/terpene); (4) polyterpene resins and hydrogenated polyterpene resins; (5) phenolic modified terpene resins and hydrogenated derivatives thereof (for example, the resin product resulting from the condensation, in an acidic medium, of a bicyclic terpene and a phenol); (6) aliphatic or cycloaliphatic hydrocarbon resins and the hydrogenated derivatives thereof (for example, resins resulting from the polymerization of monomers consisting primarily of olefins and diolefins); (7) aromatic hydrocarbon resins and the hydrogenated derivatives thereof, (8) aromatic modified aliphatic or cycloaliphatic hydrocarbon resins and the hydrogenated derivatives thereof, and combinations thereof. In one embodiment, or a combination of two or more embodiments, each described herein, the tackifier is selected from hydrogenated hydrocarbons.

### Other Additives

An inventive composition may include one or more additives. Additives include, but are not limited to, fillers (for example, carbon black and talc), foaming agents (for example, AC and OBSH), antioxidants, colorants and processing aids (for example, zinc stearate). In an embodiment, the composition comprises at least one antioxidant. An antioxidant protects the composition from degradation caused by reaction with oxygen, induced by such things as heat, light, or residual catalyst present in a commercial material. Suitable antioxidants include those commercially available from BASF, such as, IRGANOX 1010, IRGANOX B225, IRGANOX 1076 and IRGANOX 1726. These antioxidants, which act as radical scavengers, may be used alone, or in combination with other antioxidants, such as phosphite antioxidants, like IRGAFOS 168, also available from BASF. In an embodiment, the composition comprises from 0.01 wt %, or 0.02 wt %, or 0.04 wt %, or 0.06 wt %, or 0.08 wt %, or 0.10 wt %, or 0.20 wt % to 0.30 wt %, or 0.40 wt %, or 0.50 wt %, or 0.60 wt %, or 0.80 wt % or 1.00 wt % of at least one antioxidant. Weight percent is based on total weight of the composition.

### Definitions

Unless stated to the contrary, implicit from the context, or customary in the art, all parts and percentages are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers, such as one or more antioxidants.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, at least 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, at least 50 wt % or a majority weight percent of propylene (based on the weight of the polymer), and optionally may comprise one or more comonomers.

The term “ethylene-based polymer,” as used herein, refers to a polymer that comprises, in polymerized form, at least 50 wt % or a majority weight percent of ethylene (based on the weight of the polymer), and optionally may comprise one or more comonomers.

The term “ethylene/alpha-olefin interpolymer,” as used herein, refers to a random interpolymer that comprises, in polymerized form, at least 50 wt % or a majority weight percent of ethylene (based on the weight of the interpolymer), and an alpha-olefin.

The term, “ethylene/alpha-olefin copolymer,” as used herein, refers to a random copolymer that comprises, in polymerized form, at least 50 wt % or a majority amount of ethylene monomer (based on the weight of the copolymer), and an alpha-olefin, as the only two monomer types.

The term “ethylene/alpha-olefin multi-block interpolymer,” as used herein, refers to a multi-block interpolymer that comprises, in polymerized form, at least 50 wt % or a majority weight percent of ethylene (based on the weight of the interpolymer), and an alpha-olefin.

The term “ethylene/alpha-olefin multi-block copolymer,” as used herein, refers to a multi-block copolymer that comprises, in polymerized form, at least 50 wt % or a majority weight percent of ethylene monomer (based on the weight of the copolymer), and an alpha-olefin, as the only two monomer types. See also prior discussion.

The phrase “a majority weight percent,” as used herein, in reference to a polymer (or interpolymer, or terpolymer or copolymer), refers to the amount of monomer present in the greatest amount in the polymer.

The terms “thermally treating,” “thermal treatment,” and similar terms, as used herein, in reference to a composition, refer to the application of heat to the composition. Heat may be applied by electrical means (for example, a heating coil) and/or by radiation and/or by hot oil and/or by mechanical shearing. Note, the temperature at which the thermal treatment takes place, refers to the temperature of the composition (for example, the melt temperature of the composition).

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Composition Features

A] A composition comprising at least the following components:
   a) at least one olefin-based interpolymer that comprises the following properties:
      i) a melt index (I2)≤30 dg/min or a melt flow rate (MFR)≤30 dg/min,
   b) a tackifier; and
      wherein the composition has a melt index (I2)≤10 g/10 min.
B] The composition of A] above, wherein the composition has a “Bally Flex Failure Cycles” value ≥90 k, or ≥95 k, or ≥100 k, or ≥100 k.
C] The composition of A] or B] above, wherein the composition has a melt index (I2)≥1.0, or ≥1.5, or ≥2.0, or ≥2.5, or ≥3.0, or ≥3.5, or ≥4.0 g/10 min.
D] The composition of any one of A]-C](A] through C]) above, wherein the composition has a melt index (I2)≤9.5, or ≤9.0, or ≤8.5, or ≤8.0, or ≤7.8, or ≤7.6, or ≤7.4 dg/min.
E] The composition of any one of A]-D]above, wherein the weight ratio of component a to component b is ≥0.8, or ≥1.0, or ≥1.2, or ≥1.4, or ≥1.6, or ≥1.8, or ≥2.0, or ≥2.1, or ≥2.2.
F] The composition of any one of A]-E]above, wherein the weight ratio of component a to component b is ≤20, or ≤19, or ≤18, or ≤16, or ≤14, or ≤12, or ≤10, or ≤8.0, or ≤7.0, or ≤6.5, or ≤6.0, or ≤5.9, or ≤5.8, or ≤5.7, or ≤5.6.
G] The composition of any one of A]-F]above, wherein the composition has a Flexural Modulus ≥2.0, or ≥3.0, or ≥3.5, or ≥4.0, or ≥4.5, or ≥5.0, or ≥5.5, or ≥6.0, or ≥6s.5, or ≥7.0, or ≥8.5, or ≥9.0, or ≥9.5, or ≥10.0, or ≥10.5, or ≥11.0, or ≥11.5, or ≥12.0, or ≥12.5 MPa, and/or ≤50.0, or ≤40.0, or ≤30.0 MPa.
H] The composition of any one of A]-G]above, wherein the composition has a Shore A Hardness ≥20, or ≥30, or ≥40, or ≥42, or ≥44, or ≥46, or ≥48, or ≥50, or ≥52, or ≥54, or ≥56, or ≥58, or ≥60, and/or ≤80.0, or ≤78.0, or ≤76.0, or ≤74.0, or ≤72.0, or ≤70.0.
I] The composition of any one of A]-H]above, wherein the component a is at least one ethylene-based interpolymer.
J] The composition of I] above, wherein the ethylene-based interpolymer (of component a) has a melt index (I2)≥0.2, or ≥0.4, or ≥0.6, or ≥0.8, or ≥0.9, or ≥1.0 g/10 min.
K] The composition of I] or J] above, wherein the ethylene-based interpolymer (of component a) has a melt index (I2)≤28, or ≤26, or ≤24, or ≤22, or ≤20, or ≤18, or ≤16 g/10 min.
L] The composition of any one of I]-K]above, wherein the ethylene-based interpolymer (of component a) has a density ≥0.856 g/cc, or ≥0.858 g/cc, or ≥0.860 g/cc, or ≥0.862 g/cc, or ≥0.863 g/cc, or ≥0.864 g/cc, or ≥0.866 g/cc, or ≥0.868 g/cc, or ≥0.870 g/cc.
M] The composition of any one of I]-L]above, wherein the ethylene-based interpolymer (of component a) has a density ≤0.900 g/cc, or 0.895 g/cc, or ≤0.890 g/cc, or ≤0.888 g/cc, or ≤0.887 g/cc, or ≤0.886 g/cc, or ≤0.884 g/cc, or ≤0.882 g/cc, or ≤0.880 g/cc.
N] The composition of any one of I]-M]above, wherein the ethylene-based interpolymer (of component a) has a melting temperature (Tₘ)≥40° C., ≥45° C., ≥50° C., ≥55° C., and/or ≤140° C., or 135° C., or 130° C., or ≤125° C., or 120° C.
O] The composition of any one of I]-N]above, wherein the ethylene-based interpolymer (of component a) has a molecular weight distribution (MWD=Mw/Mn)≥1.5, or ≥1.6, or ≥1.7, or ≥1.8, or ≥1.9 and/or 5.0, or ≤4.5, or ≤4.0, or ≤3.5, or ≤3.0, or ≤2.8, or ≤2.7, or ≤2.6, or ≤2.5, or ≤2.4, or ≤2.3.
P] The composition of any one of I]-O]above, wherein the ethylene-based interpolymer (of component a) has a number average molecular weight (Mn)≥10,000 g/mol, or ≥15,000 g/mol, or ≥20,000 g/mol, or ≥25,000 g/mol, or ≥30,000 g/mol, or ≥32,000 g/mol, or ≥35,000 g/mol and/or ≤100,000 g/mol, or ≤90,000 g/mol, or ≤80,000 g/mol, or ≤75,000 g/mol, or ≤70,000 g/mol, or ≤65,000 g/mol, or ≤60,000 g/mol.
Q] The composition of any one of I]-P]above, wherein the ethylene-based interpolymer (of component a) has a glass transition temperature (Tg)≥−70.0° C., or ≥−65.0° C., or ≥−60.0° C., or ≥−55.0° C., as determined by DSC, and/or ≤−30.0° C., or ≤−35.0° C., or ≤−40.0° C., or ≤−45.0° C., or ≤−50.0° C., as determined by DSC.
R] The composition of any one of I]-Q]above, wherein the ethylene-based interpolymer (of component a) is an ethylene/alpha-olefin interpolymer.
S] The composition of R] above, wherein the alpha-olefin of the ethylene/alpha-olefin interpolymer is a C3-C20 alpha-olefin, further a C3-C10 alpha-olefin, and further a C3-C8 alpha-olefin.
T] The composition of R] or S] above, wherein the alpha-olefin of the ethylene/alpha-olefin interpolymer is selected from propylene, 1-butene, 1-pentene, 1-hexene or 1-octene, and further propylene, 1-butene or 1-octene, and further 1-butene or 1-octene, and further 1-octene.
U] The composition of any one of R]-T]above, wherein the ethylene/alpha-olefin interpolymer is an ethylene/alpha-olefin copolymer.
V] The composition of any one of R]-U]above, wherein the ethylene/alpha-olefin interpolymer is selected from the following: an ethylene/propylene copolymer, an ethylene/butene copolymer, or an ethylene/octene copolymer, and further an ethylene/butene copolymer, or an ethylene/octene copolymer, and further an ethylene/octene copolymer.
W] The composition of any one of I]-Q]above, wherein the ethylene-based interpolymer (of component a) is an ethylene/alpha-olefin multiblock interpolymer.
X] The composition of W] above, wherein the alpha-olefin of the ethylene/alpha-olefin multiblock interpolymer is a C3-C20 alpha-olefin, and further a C3-C10 alpha-olefin, and further a C3-C8 alpha-olefin.
Y] The composition of W] or X] above, wherein the alpha-olefin of the ethylene/alpha-olefin multiblock interpolymer is selected from propylene, 1-butene, 1-pentene, 1-hexene or 1-octene, and further propylene, 1-butene or 1-octene, and further 1-butene or 1-octene, and further 1-octene.

Z] The composition of any one of W]-Y]above, wherein the ethylene/alpha-olefin multiblock interpolymer is an ethylene/alpha-olefin multiblock copolymer.
A2] The composition of any one of W]-Z]above, wherein the ethylene/alpha-olefin multiblock interpolymer is selected from the following: an ethylene/propylene multiblock copolymer, an ethylene/butene multiblock copolymer, or an ethylene/octene multiblock copolymer, and further an ethylene/butene multiblock copolymer, or an ethylene/octene multiblock copolymer, and further an ethylene/octene multiblock copolymer.
B2] The composition of any one of A]-Q]above, wherein the component a is an ethylene/alpha-olefin interpolymer and an ethylene/alpha-olefin multiblock interpolymer.
C2] The composition of B2] above, wherein the alpha-olefins of the ethylene/alpha-olefin interpolymer and an ethylene/alpha-olefin multiblock interpolymer are each independently a C3-C20 alpha-olefin, and further a C3-C10 alpha-olefin, and further a C3-C8 alpha-olefin.
D2] The composition of B2] or C2] above, wherein the alpha-olefins of the ethylene/alpha-olefin interpolymer and the ethylene/alpha-olefin multiblock interpolymer are each independently a selected from propylene, 1-butene, 1-pentene, 1-hexene or 1-octene, and further propylene, 1-butene or 1-octene, and further 1-butene or 1-octene, and further 1-octene.
E2] The composition of any one of B2]-D2] above, wherein the ethylene/alpha-olefin multiblock interpolymer is an ethylene/alpha-olefin multiblock copolymer.
F2] The composition of any one of B2]-E2] above, wherein the ethylene/alpha-olefin interpolymer is an ethylene/alpha-olefin copolymer.
G2] The composition of any one of B2]-F2] above, wherein the ethylene/alpha-olefin multiblock interpolymer is selected from the following: an ethylene/propylene multiblock copolymer, an ethylene/butene multiblock copolymer, or an ethylene/octene multiblock copolymer, and further an ethylene/butene multiblock copolymer, or an ethylene/octene multiblock copolymer, and further an ethylene/octene multiblock copolymer.
H2] The composition of any one of B2]-G2] above, wherein the ethylene/alpha-olefin interpolymer is selected from the following: an ethylene/propylene copolymer, an ethylene/butene copolymer, or an ethylene/octene copolymer, and further an ethylene/butene copolymer, or an ethylene/octene copolymer, and further an ethylene/octene copolymer.
I2] The composition of any one of B2]-H2] above, wherein the weight ratio of the ethylene/alpha-olefin interpolymer to the ethylene/alpha-olefin multiblock interpolymer is ≥0.80, or ≥0.85, or ≥0.90, or ≥0.95, or ≥1.0.
J2] The composition of any one of B2]-I2] above, wherein the weight ratio of the ethylene/alpha-olefin interpolymer to the ethylene/alpha-olefin multiblock interpolymer is ≤3.0, or ≤2.8, or ≤2.6, or ≤2.4, or ≤2.2, or ≤2.0, or ≤1.8, or ≤1.6, or ≤1.4, or ≤1.2, or ≤1.1.
K2] The composition of any one of B2]-J2] above, wherein the ratio of the melt index (I2) of the ethylene/alpha-olefin multiblock interpolymer to the melt index (I2) of the ethylene/alpha-olefin interpolymer is ≥0.80, or ≥0.85, or ≥0.90, or ≥0.95, or ≥1.0, and/or ≤40, or ≤35, or ≤30, or ≤25, or ≤20, or ≤15, or ≤10, or ≤5.0, or ≤2.0.
L2] The composition of any one of B2]-K2] above, wherein the ratio of the density of the ethylene/alpha-olefin multiblock interpolymer to the density of the ethylene/alpha-olefin interpolymer is ≥0.800, or ≥0.850, or ≥0.900, or ≥0.950, or ≥0.980, or ≥1.00, and/or ≤1.30, or ≤1.25, or ≤1.20, or ≤1.15, or ≤1.10, or ≤1.05, or ≤1.04, or ≤1.03, or ≤1.02.
M2] The composition of any one of A]-H]above, wherein the component a is at least one propylene-based interpolymer.
N2] The composition of any one of M2] above, wherein the propylene-based interpolymer (of component a) has a melt flow rate (MFR)≥0.2, or ≥0.4, or ≥0.6, or ≥0.8, or ≥0.9, or ≥1.0, or ≥1.2, or ≥1.4, or ≥1.6, or ≥1.8 g/10 min. 02] The composition of M2] or N2] above, wherein the propylene-based interpolymer (of component a) has a melt flow rate (MFR)≤10, or 8.0, or ≤6.0, or ≤4.0, or 3.0, or ≤2.8, or ≤2.6, or ≤2.4, or ≤2.2, or ≤2.0 g/10 min.
P2] The composition of any one of M2]-02] above, wherein the propylene-based interpolymer (of component a) has a density ≥0.856 g/cc, or ≥0.858 g/cc, or ≥0.860 g/cc, or ≥0.861 g/cc, or ≥0.862 g/cc, or ≥0.863 g/cc.
Q2] The composition of any one of M2]-P2] above, wherein the propylene-based interpolymer (of component a) has a density ≤0.900 g/cc, or ≤0.895 g/cc, or ≤0.890 g/cc, or ≤0.885 g/cc, or ≤0.880 g/cc, or ≤0.875 g/cc, or ≤0.870 g/cc.
R2] The composition of any one of M2]-Q2] above, wherein the propylene-based interpolymer (of component a) has a melting temperature (Tₘ)≥30° C., or ≥40° C., or ≥45° C., or ≥50° C., or ≥55° C., or ≥60° C., or ≥65° C., or ≥70° C., or ≥75° C., or ≥80° C., ≥85° C. and/or 150° C., or ≤140° C., or ≤130° C., or ≤120° C., or ≤110° C., or ≤100° C., or ≤90° C.
S2] The composition of any one of M2]-R2] above, wherein the propylene-based interpolymer (of component a) has a molecular weight distribution (MWD=Mw/Mn)≥1.5, or ≥1.6, or ≥1.7, or ≥1.8, or ≥1.9 and/or ≤5.0, or ≤4.5, or ≤4.0, or ≤3.5, or ≤3.0, or ≤2.8, or ≤2.7, or ≤2.6, or ≤2.5, or ≤2.4, or ≤2.3.
T2] The composition of any one of M2]-S2] above, wherein the propylene-based interpolymer (of component a) has a number average molecular weight (Mn)≥10,000 g/mol, or ≥15,000 g/mol, or ≥20,000 g/mol, or ≥25,000 g/mol, or ≥30,000 g/mol, or ≥32,000 g/mol, or ≥35,000 g/mol and/or ≤100,000 g/mol, or ≤90,000 g/mol, or ≤80,000 g/mol, or ≤75,000 g/mol, or ≤70,000 g/mol, or ≤65,000 g/mol, or ≤60,000 g/mol.
U2] The composition of any one of M2]-T2] above, wherein the propylene-based polymer is an propylene/ethylene interpolymer or a propylene/alpha-olefin interpolymer, and further a propylene/ethylene interpolymer, further a propylene/ethylene copolymer.
V2] The composition of U2] above, wherein the alpha-olefin of the propylene/alpha-olefin interpolymer is a C4-C20 alpha-olefin, and further a C4-C10 alpha-olefin, and further a C4-C8 alpha-olefin.
W2] The composition of U2] or V2] above, wherein the alpha-olefin of the propylene/alpha-olefin interpolymer is selected from 1-butene, 1-pentene, 1-hexene or 1-octene, and further 1-butene or 1-octene, and further 1-octene.
X2] The composition of any one of U2]-W2] above, wherein the propylene/ethylene interpolymer is a propylene/ethylene copolymer, and the propylene/alpha-olefin interpolymer is the propylene/alpha-olefin copolymer.
Y2] The composition of any one of U2]-X2] above, wherein the propylene/alpha-olefin interpolymer is selected from the following: a propylene/butene copolymer, or a propylene/octene copolymer, and further a propylene/octene copolymer.
Z2] The composition of any one of A]-Y2] above, wherein the tackifier (component b) is selected from a hydrogenated aliphatic resin, a cycloaliphatic hydrocarbon resin, an aliphatic C5 resin, an aromatic modified aliphatic C5 tackifier, or any combination thereof.
A3] The composition of any one of A]-Z2] above, wherein the tackifier (component b) has a number average molecular weight (Mn)≥300, or ≥400, or ≥500, g/mol, and/or ≤2000, or ≤1900, or ≤1800, or ≤1750 or ≤1700, or ≤1650, or ≤1600, or ≤1550, or ≤1500 g/mol.
B3] The composition of any one of A]-A3] above, wherein the tackifier (component b) has a density is ≥0.90, or ≥0.95, or ≥1.00 g/cc, and/or 1.10, or ≤1.08, or ≤1.06, or ≤1.04, or ≤1.02 g/cc.
C3] The composition of any one of A]-B3] above, wherein the composition comprises ≥50 wt %, or ≥55 wt %, or ≥60 wt %, or ≥65 wt %, or ≥70 wt %, or ≥75 wt %, of component a, based on the weight of the composition.
D3] The composition of any one of A]-C3] above, wherein the composition comprises ≤95 wt %, or ≤90 wt %, or 85 wt % of component a, based on the weight of the composition.
E3] The composition of any one of A]-D3] above, wherein the composition comprises at comprises ≥5.0 wt %, or ≥7.0 wt %, or ≥8.0 wt %, or ≥10 wt %, or ≥12 wt %, or ≥14 wt %, or ≥16 wt % or ≥18 wt %, or ≥20 wt %, or ≥22 wt %, or ≥24 wt % of component b, based on the weight of the composition.
F3] The composition of any one of A]-E3] above, wherein the composition comprises ≤75 wt %, or ≤70 wt %, or ≤65 wt %, or ≤60 wt %, or ≤55 wt %, or ≤50 wt %, or ≤45 wt %, or ≤40 wt %, or ≤38 wt %, or ≤36 wt %, or ≤34 wt %, or ≤32 wt %, or ≤30 wt % of component b, based on the weight of the composition.
G3] The composition of any one of A]-F3] above, wherein the composition comprises ≥60 wt %, ≥70 wt %, or ≥80 wt %, or ≥85 wt %, or ≥90 wt %, or ≥92 wt %, or ≥94 wt %, or ≥96 wt % of the sum of components a and b, based on the weight of the composition.
H3] The composition of any one of A]-G3] above, wherein the composition comprises ≤100 wt %, or ≤99 wt %, ≤98 wt %, or ≤97 wt % of the sum of components a and b, based on the weight of the composition.
I3] The composition of any one of A]-H3] above, wherein the composition further comprises at least one filler (component c).
J3] The composition of 13] above, wherein the composition comprises ≥0.5 wt %, or 1.0 wt %, or ≥2.0 wt %, or ≥5.0 wt %, or ≥10 wt % of the filler (component c), and/or ≤40 wt %, or ≤35 wt %, or ≤30 wt %, or 25 wt %, or ≤20 wt % of the filler (component c), based on the weight of the composition.
K3] The composition of any one of A]-J3] above, wherein the composition further comprises a thermoplastic polymer, different from the olefin-based interpolymer (component a), in one or more features, such as monomer types, monomer distributions, monomer amounts, density, melt index (I2) or melt flow rate (MFR), Mn, Mw, MWD, or any combination thereof, and further in one or more features, such as monomer types, monomer distributions, monomer amounts, density, melt index (I2) or melt flow rate (MFR), or any combination thereof.
L3] The composition of any one of A]-K3] above, wherein the composition has a melt viscosity (177° C.)≥300,000 mPa·s, or ≥350,000 mPa·s, or ≥400,000 mPa·s, or ≥500,000 mPa s, or ≥600,000 mPa s, or ≥700,000 mPa s, or ≥800,000 mPa s, or ≥900,000 mPa s, or ≥1,000,000 mPa s, and/or 20,000,000 mPa s, or ≤10,000,000 mPa s.
M3] The composition of any one of A]-L3] above, wherein the composition comprises ≤2.0 wt % or ≤1.0 wt %, or ≤0.5 wt %, or ≤0.2 wt %, or ≤0.1 wt %, or ≤0.05 wt % of an oil, based on the weight of the composition; and further the composition does not comprises an oil.
N3] The composition of any one of A]-M3] above, wherein the composition comprises ≤2.0 wt % or ≤1.0 wt %, or ≤0.5 wt %, or ≤0.2 wt %, or ≤0.1 wt %, or ≤0.05 wt % of a wax, based on the weight of the composition; and further the composition does not comprises a wax.
O3] An article comprising at least one component formed from the composition of any one of A]-N3] above.
P3] The article of 03] above, wherein the article is artificial leather.
Q3]A method of forming artificial leather, said method comprising mixing the composition of any one of A]-N3] above.
R3] The method of Q3] above, wherein the method further comprises thermally treating the composition.
S3] The method of R3] above, wherein the composition is thermally treated at a temperature ≥80° C., or ≥90° C., or ≥100° C., or ≥110° C., or ≥120° C., or 130° C., or 140° C. and/or ≤200° C., or ≤190° C., or ≤180° C., or ≤170° C. or ≤165° C., or ≤160° C.

### Test Methods

### Melt Index or Melt Flow Rate of a Polymer

The melt index MI (or 12) of an ethylene-based polymer is measured in accordance with ASTM D-1238, condition 190° C./2.16 kg. The melt flow rate MFR of a propylene-based polymer is measured in accordance with ASTM D-1238, condition 230° C./2.16 kg.

### Melt Index of a Composition

The melt index MI (or 12) of a composition is measured in accordance with ASTM D-1238, condition 190° C./2.16 kg.

### Density

The density of a polymer is measured by preparing the polymer sample according to ASTM D 1928, and then measuring the density according to ASTM D792, Method B, within one hour of sample pressing.

### Differential Scanning Calorimetry (DSC)

Differential Scanning Calorimetry (DSC) is used to measure Tm, Tc, Tg and crystallinity in ethylene-based (PE) and propylene-based (PP) samples. Each sample (0.5 g) is compression molded into a film, at 25000 psi, 190° C., from 10 to 15 seconds. About 5 to 8 mg of film sample is weighed and placed in a DSC pan. The lid is crimped on the pan to ensure a closed atmosphere. The sample pan is placed in a DSC cell, and then heated, at a rate of approximately 10° C./min, to a temperature of 180° C. for PE (230° C. for PP). The sample is kept at this temperature for three minutes. Then the sample is cooled at a rate of 10° C./min to −90° C. for PE (−60° C. for PP), and kept isothermally at that temperature for three minutes. The sample is next heated at a rate of 10° C./min, until complete melting (second heat). Unless otherwise stated, melting point (Tₘ) and the glass transition temperature (Tg) of each polymer sample are determined from the second heat curve, and the crystallization temperature (Tc) is determined from the first cooling curve. The Tg and the respective peak temperatures for the Tm and the Tc are recorded. The percent crystallinity can be calculated by dividing the heat of fusion (Hf), determined from the second heat curve, by a theoretical heat of fusion of 292 J/g for PE (165 J/g for PP), and multiplying this quantity by 100 (for example, % cryst.=(Hf/292 J/g)×100 (for PE)).

### Viscosity of the Polymer

The viscosity of a composition was measured using Dynamic Mechanical spectroscopy (DMS) analysis. The instrument AR2000ex from TA Instruments was used with a geometry of “25 mm” parallel plates. The test method included an oscillatory frequency sweep; a temperature of 177° C., an angular frequency of 1 to 100 rad/s, and a strain of 5%. The viscosity at 100 rad/s was used for flowability comparison of the noted compositions in Tables 2 and 3 below.

### Gel Permeation Chromatography (GPC)—Ethylene-based Polymers

The chromatographic system consists of a PolymerChar GPC-IR (Valencia, Spain) high temperature GPC chromatograph, equipped with an internal IR5 infra-red detector (IR5). The autosampler oven compartment is set at 1600 Celsius, and the column compart-ment is set at 1500 Celsius. The columns are four AGILENT “Mixed A” 30 cm, 20-micron linear mixed-bed columns. The chromatographic solvent is 1,2,4-trichlorobenzene, which contained 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80° Celsius, with gentle agitation, for 30 minutes. The polystyrene standard peak molecular weights are converted to polyethylene molecular weights using Equation 1 (as described in Williams and Ward, J. Polym. Sci., Polym. Let., 6, 621 (1968)): M_{polyethylene}=A×(M_{polystyrene})^{B} (EQ1), where M is the molecular weight, A has a value of 0.4315 and B is equal to 1.0.

A fifth order polynomial is used to fit the respective polyethylene equivalent calibration points. A small adjustment to A (from approximately 0.375 to 0.445) is made to correct for column resolution and band-broadening effects, such that linear homopolymer polyethylene standard is obtained at 120,000 Mw.

The total plate count of the GPC column set is performed with decane (prepared at “0.04 g in 50 milliliters” of TCB, and dissolved for 20 minutes with gentle agitation). The plate count (Equation 2) and symmetry (Equation 3) are measured on a 200 microliter injection according to the following equations:

$$Plate Count = 5.54 * {( \frac{( R {V}_{Peak Max}}{Peak Width at \frac{1}{2} height} )}^{2} , \qquad ( EQ2 )$$

where RV is the retention volume in milliliters, the peak width is in milliliters, the peak max is the maximum height of the peak,

$$Symmetry = \frac{( Rear Peak R {V}_{one tenth height} - R {V}_{Peak max} )}{( R {V}_{Peak max} - Front Peak R {V}_{one tenth height} )} , \qquad ( EQ3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contained 200 ppm BHT) is added to a pre nitrogen-sparged, septa-capped vial, via the PolymerChar high temperature autosampler. The samples are dissolved for two hours at 160° Celsius under “low speed” shaking.

The calculations of Mn_{(GPC)}, Mw_{(GPC)}, and Mz_{(GPC)} are based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} I {R}_{i}}{{\sum }^{i} ( I {R}_{i} / {M}_{{polyethylene}_{i}} )} , \qquad ( EQ 4 )$$

$${Mw}_{( GPC )} = \frac{{\sum }^{i} ( I {R}_{i} * {M}_{{polyethylene}_{i}} )}{{\sum }^{i} {IR}_{i}} , and \qquad ( EQ 5 )$$

$${M𝓏}_{( GPC )} = \frac{{\sum }^{i} ( I {R}_{i} * {M}_{{polyethylene}_{i}}^{2} )}{{\sum }^{i} ( I {R}_{i} * {M}_{{polyethylene}_{i}} )} . \qquad ( EQ 6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated from Equation 7: Flowrate(effective)=Flowrate(nominal)*(RV(FM Calibrated)/RV(FM Sample)) (EQ7). Processing of the flow marker peak is done via the PolymerChar GPCOne™ software. Acceptable flowrate correction is such that the effective flowrate should be within +/−0.7% of the nominal flowrate.

### Gel Permeation Chromatography (GPC)—Propylene-based Polymers

A high temperature Gel Permeation Chromatography (GPC) system, equipped with Robotic Assistant Deliver (RAD) system for sample preparation and sample injection, is used. The concentration detector is an Infra-red detector (IR4) from Polymer Char Inc. (Valencia, Spain). Data collection is performed using Polymer Char DM 100 Data acquisition box. The system is equipped with an on-line solvent degas device from Agilent. The column compartment is operated at 150° C. The columns are four, Mixed A LS 30 cm, 20 micron columns. The solvent is nitrogen (N2) purged, 1,2,4-trichlorobenzene (TCB), containing approximately “200 ppm” of 2,6-di-t-butyl-4-methylphenol (BHT). The flow rate is 1.0 mL/min, and the injection volume is 200 μl. A “2 mg/mL” sample concentration is prepared by dissolving the sample in N2 purged and preheated TCB (containing 200 ppm BHT), for 2.5 hours at 160° C., with gentle agitation.

The GPC column set is calibrated by running twenty narrow molecular weight distribution polystyrene (PS) standards. The molecular weight (MW) of the standards range from 580 to 8,400,000 g/mol, and the standards are contained in six “cocktail” mixtures.

Each standard mixture has at least a decade of separation between individual molecular weights. The equivalent polypropylene molecular weight of each PS standard is calculated using the following equation (1), with reported Mark-Houwink coefficients for polypropylene (Th. G. Scholte, N. L. J. Meijerink, H. M. Schoffeleers, and A. M. G. Brands, J. Appl. Polym. Sci., 29, 3763-3782 (1984)) and polystyrene (E. P. Otocka, R. J. Roe, N. Y. Hellman, P. M. Muglia, Macromolecules, 4, 507 (1971)):

$${M}_{PP} = {( \frac{{K}_{PS} {M}_{PS}^{{a}_{PS} + 1}}{{K}_{PP}} )}^{\frac{1}{{a}_{PP} + 1}} ,$$

where M_{PP} is PP equivalent MW, M_{PS} is PS equivalent MW. The log K and a values of Mark-Houwink coefficients for PP and PS are listed below in Table A.

TABLE A

| Polymer | a | logK |
|---|---|---|
| Polypropylene | 0.725 | −3.721 |
| Polystyrene | 0.702 | −3.900 |

A logarithmic molecular weight calibration is generated using a fourth order polynomial fit as a function of elution volume. Number average and weight average molecular weights are calculated according to the following equations:

$${M}_{n} = \frac{{\sum }^{i} W {f}_{i}}{{\sum }^{i} ( W {f}_{i} / {M}_{i} )} , \qquad ( 2 )$$

$${M}_{w} = \frac{{\sum }^{i} ( W {f}_{i} * {M}_{i} )}{{\sum }^{i} ( W {f}_{i} )} , \qquad ( 3 )$$

where w_{fi} and Mᵢ, are the weight fraction and molecular weight of elution component i, respectively (note, MWD=Mw/Mn).

### EXPERIMENTAL

Interpolymers and tackifiers are shown in Table 1.

TABLE 1
Polymers and Tackifiers

| | Product | | |
|---|---|---|---|
| | Name | Chemical Description | Source |
| Ethylene- | INFUSE ™ | Olefin block copolymer, | Dow |
| based | 9100 | density 0.877 g/cc, MI 1 g/10 | |
| | | min (at 190° C./2.16 kg), | |
| | | Tm = 120° C. | |
| Ethylene- | INFUSE ™ | Olefin block copolymer, | Dow |
| based | 9807 | density 0.866 g/cc, MI 15 | |
| | | g/10 min (at 190° C./2.16 | |
| | | kg), Tm = 118° C. | |
| Ethylene- | INFUSE ™ | Olefin block copolymer, | Dow |
| based | 9130 | density 0.886 g/cc, MI 1.5 | |
| | | g/10 min (at 190° C./2.16 kg) | |
| Ethylene- | ENGAGE ™ | Ethylene/octene copolymer | Dow |
| based | 8100 | density 0.87 g/cc, MI 1 g/10 | |
| | | min (at 190° C./2.16 kg), | |
| | | Shore A = 73, Tm = 60.0° | |
| | | C., Tg = −52.0° C. | |
| Ethylene- | ENGAGE ™ | Ethylene/octene copolymer | Dow |
| based | 8180 | density 0.863 g/cc, MI 0.5 | |
| | | g/10 min (at 190° C./2.16 kg), | |
| | | Shore A = 63, Tm = | |
| | | 47.0° C., Tg = −55.0° C. | |
| Propylene- | VERSIFY ™ | density 0.863 g/cc, | Dow |
| based | DE2400.05 | MFR 2 g/10 min (at 230° C./ | |
| | | 2.16 kg) | |
| Tackifier | EASTOTAC | Hydrogenated aliphatic resin, | Eastman |
| | C-100W Resin | density 1.01 g/ml, Mn 550 | |
| Tackifier | ESCOREZ | Cycloaliphatic hydrocarbon | ExxonMobil |
| | 5400 | resin; amorphous, glassy, | |
| | | low-molecular-weight hydro- | |
| | | carbon polymer, Mn 400 | |
| Tackifier | PICCOTAC | Relatively high molecular | Eastman |
| | 1115 | weight, aliphatic C5 resin | |
| | | derived from dienes and other | |
| | | reactive olefin monomers, | |
| | | Mn 1500 | |
| Tackifier | PICCOTAC | Aromatic-modified aliphatic | Eastman |
| | 8095 | C5 tackifier, Mn 930 | |

### Brabender Mixing and Compression Molding

For each composition, polymer or polymers (260 grams) were fed into a 350 ml chamber of Brabender mixer at a set temperature of 160° C. and with a rotor speed of 30 rpm. After about two minutes, the resins were homogeneously heated and melted. Afterwards, all other ingredients, were weighed and gradually added into the mixing chamber. The mixing was continued at 60 rpm for another eight minutes, to form a homogeneous compound.

The composition from the Brabender mixer was compression molded into a plaque in a “1.0 mm” thick mold. The compound was preheated at 160° C. for five minutes, and then degassed (repeated compression at 10 MPa and release, for six times), followed by another two minutes at a pressure of 10 MPa and a temperature of 160° C. The plaques (dimensions: 15 cm×7 cm×1.1 mm) were taken out from the mold after ramping the temperature down to room temperature. The obtained plaques were further cut into required shape and size of 38 mm×63 mm×1.1 mm for the for bally flex test.

For Shore A and flexural modulus test, “3.0 mm thick” plaques were compression molded (molding conditions: 160° C., 10 MPa, 3 minutes, 30 grams, and dimensions: 100 mm×100 mm). The “3.0 mm” plaques were cut into pellets for melt index test.

Bally flex test: This test method was used to evaluate resistance to cracking of the thin (1.1 mm) plaques of the inventive and comparative compositions, when subjected to repeated flexing. The test conformed to ASTM D6182-00. The Bally Flexometer conformed to DIN 53351, and operated at a rate of 100 cycles/min. The end of the test was determined by the number of cycles, at which cracking of the plaque's front surface was observed, and was reported as the bally flex result. Two specimens were tested for each composition, and the average value was reported. If no crack/damage was observed after 100 k cycles for the two specimens, the result was reported as ≥100 k.

Shore A hardness was measured in accordance with ASTM D2240. Load 0.5 kg, duration time 5 seconds. Two, “3 mm thick” plaques were stacked together for the test.

Flexural modulus was measured according to ASTM D790. The “3 mm thick” plaques were cut into small bars (126 mm×12.6 mm) for the test.

Results are shown in Tables 2 and 3. As seen in Tables 2 and 3, it is clear that the inventive compositions had significantly improved bally flex (bally flex failure cycles were increased to 100 k or more), and, at the same time, significantly increased melt index and decreased Shore A and flexural modulus. The inventive compositions are especially suitable for artificial leather, with a good balance of excellent bally flex resistance, good flowability for processing, and a high degree of softness for good hand-feel. Such balance cannot be achieved by the comparative compositions.

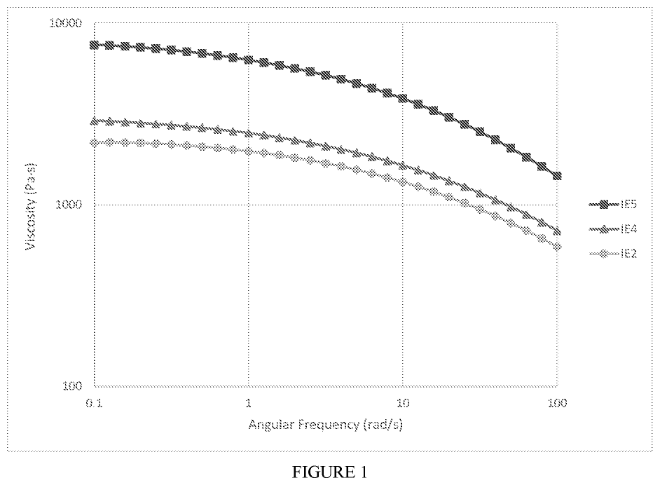

The DMS (177° C.) profiles for inventive compositions IE2, IE4 and IE5 are shown in FIG. 1, and the respective viscosities, at an angular frequency of 100 rad/s, are listed in Tables 2 and 3. It is noted that the angular frequency for a Brookfield (melt) viscosity at 177° C., is significantly lower than “100 rad/s.” Thus, for a composition with an 12 of about 2 g/10 min (for example, see IE5), the Brookfield (melt) viscosity (i.e., viscosity tested at an angular frequency in the Brookfield method) at 177° C. is >>1,400,000 mPa s. For a composition with an 12 of about 5 g/10 min (for example, see IE4), the Brookfield (melt) viscosity at 177° C. is >>720,000 mPa s. For a composition with an 12 of about 7 g/10 min (for example, see IE2), the Brookfield (melt) viscosity at 177° C. is >>590,000 mPa s. For a composition with an 12=10 g/10 min, the Brookfield (melt) viscosity at 177° C. is >>480,000 mPa s, as determined from extrapolation of a In—In plot (see data in Tables 2 and 3).

The Brookfield viscometer cannot measure the viscosity of compositions shown in Tables 2 and 3, because the viscosities already exceed the upper limit of Brookfield method. So, the “Brookfield (melt) viscosity” here is lower limit of the viscosity value if the viscosity could be measured by the Brookfield method. Note, the viscosity measured at a normal angular frequency employed in the Brookfield method should be much higher than the viscosity value at 100 rad/s, since a lower frequency (Brookfield) results in a higher viscosity.

TABLE 2
Compositions (wt %) and Properties

| Composition | CE1 | IE1 | IE2 | IE3 | IE4 | CE2 | IE5 |
|---|---|---|---|---|---|---|---|
| INFUSE 9807 | 50 | 40 | 35 | 40 | 40 | | |
| ENGAGE 8180 | 50 | 40 | 35 | 40 | 40 | | |
| ENGAGE 8100 | | | | | | 50 | 42.5 |
| INFUSE 9100 | | | | | | 50 | 42.5 |
| INFUSE 9130 | | | | | | | |
| VERSIFY DE | | | | | | | |
| 2400.05 | | | | | | | |
| EASTOTAC C- | | 20 | 30 | | | | 15 |
| 100W | | | | | | | |
| ESCOREZ 5400 | | | | | | | |
| PICCOTAC 1115 | | | | 20 | | | |
| PICCTAC 8095 | | | | | 20 | | |
| Melt Index (I2) | 1.9 | 4.7 | 7.3 | 4.8 | 4.9 | 1 | 1.6 |
| ln(I2) | | | 2.0 | | 1.6 | | 0.47 |
| Shore A | 63 | 51 | 49 | 53 | 50 | 75 | 67 |
| Flexural Modulus | 9.1 | 5.6 | 5.1 | 4.9 | 5.4 | 21.1 | 12.7 |
| (Secant 2%) | | | | | | | |
| (MPa) | | | | | | | |
| Bally Flex | 35k | 100k | >100k | >100k | >100k | 90k | >100k |
| Failure Cycles | | | | | | | |
| Viscosity at 100 | | | 587 [587,000] | | 721 [721,000] | | 1441 [1,441,000] |
| rad/s from DMS at | | | | | | | |
| 177° C. (Pa · s) | | | | | | | |
| [mPa · s]* | | | | | | | |
| ln(DMS viscosity | | | 13.3 | | 13.5 | | 14.2 |
| (mPa · s)) | | | | | | | |

*Note,
1 Pa · s = 1000 mPa · s.
Note,
the DMS viscosity (177° C.) for an I2 = 10 was extrapolated from the plot of the ln(DMS visc.) versus the ln(I2), with a correlation of 0.9987. For an I2 = 10 g/10 min, the DMS viscosity (177° C.) is 480.700 mPa · s (ln(visc) = 13.08).
Additional composition [INFUSE 9807 (48.5 w %), ENGAGE 8180 (48.5 wt %), EASTOTAC C-100W (3 wt %)] had a Bally Flex result of 16k. Additional composition [INFUSE 9807 (10.0 w %), ENGAGE 8180 (10.0 wt %), EASTOTAC C-100W (80 wt %)] had a Bally Flex result of 10.

TABLE 3
Compositions (wt %) and Properties

| Composition | IE6 | IE7 | CE3 | IE8 | CE4 | IE9 | CE5 | IE10 |
|---|---|---|---|---|---|---|---|---|
| INFUSE 9807 | | | | | | | | |
| ENGAGE 8180 | | | | | | | | |
| ENGAGE 8100 | 35 | 30 | | | | | | |
| INFUSE 9100 | 35 | 30 | | | | | 100 | 70 |
| INFUSE 9130 | | | 100 | 70 | | | | |
| VERSIFY DE 2400.05 | | | | | 100 | 70 | | |
| EASTOTAC C-100W | 30 | 40 | | 30 | | 30 | | |
| ESCOREZ 5400 | | | | | | | | 30 |
| PICCOTAC 1115 | | | | | | | | |
| PICCTAC 8095 | | | | | | | | |
| Melt Index (I2) | 2.8 | 4.5 | 1.5 | 4.3 | 0.9 | 3.3 | 1 | 2.5 |
| ln(I2) | | | | | | | | |
| Shore A | 59 | 57 | 79 | 63 | 80 | 64 | 69 | 55 |
| Flexural Modulus | 6.4 | 6.2 | | | | | | |
| (Secant 2%) | | | | | | | | |
| (MPa) | | | | | | | | |
| Bally Flex | >100k | >100k | 55k | >100k | 85k | >100k | 67k | >100k |
| Failure Cycles | | | | | | | | |
| Viscosity at 100 rad/s from | | | | | | | | |
| DMS at 177° C. (Pa · s) | | | | | | | | |
| [mPa · s]* | | | | | | | | |
| ln(DMS viscosity (mPa · s)) | | | | | | | | |

*Note,
1 Pa · s = 1000 mPa · s.
Note,
the DMS viscosity (177° C.) for an I2 = 10 was extrapolated from the plot of the ln(DMS visc.) versus the ln(I2), with a correlation of 0.9987. For an I2 = 10 g/10 min, the DMS viscosity (177° C.) is 480.700 mPa · s (ln(visc) = 13.08).
Additional composition [INFUSE 9807 (48.5 w %), ENGAGE 8180 (48.5 wt %), EASTOTAC C-100W (3 wt %)] had a Bally Flex result of 16k. Additional composition [INFUSE 9807 (10.0 w %), ENGAGE 8180 (10.0 wt %), EASTOTAC C-100W (80 wt %)] had a Bally Flex result of 10.

1. A composition comprising at least the following components:
a) at least one olefin-based interpolymer that comprises the following properties:
i) a melt index (I2)≤30 dg/min or a melt flow rate (MFR)≤30 dg/min,
b) a tackifier; and
wherein the composition has a melt index (I2)≤10 g/10 min.

2. The composition of claim 1, wherein the composition has a Bally Flex Failure Cycles value ≥90 k.

3. The composition of claim 1, wherein the composition has a melt index (I2)≥1.0 g/10 min.

4. The composition of claim 1, wherein component b is present in an amount from 5.0 wt % to 50 wt %, based on the weight of the composition.

5. The composition of claim 1, wherein the component a is at least one ethylene-based interpolymer.

6. The composition of claim 5, wherein the ethylene-based interpolymer (component a) has a melt index (I2)≥0.2 g/10 min.

7. The composition of claim 5, wherein the ethylene-based interpolymer (component a) has a density from 0.856 g/cc to 0.900 g/cc.

8. The composition of claim 5, wherein the ethylene-based interpolymer (component a) is an ethylene/alpha-olefin interpolymer.

9. The composition of claim 8, wherein the ethylene/alpha-olefin interpolymer (component a) is an ethylene/alpha-olefin copolymer.

10. The composition of claim 5, wherein the ethylene-based interpolymer (component a) is an ethylene/alpha-olefin multiblock interpolymer.

11. The composition of claim 10, wherein the ethylene/alpha-olefin multiblock interpolymer (component a) is an ethylene/alpha-olefin multiblock copolymer.

12. The composition of claim 1, wherein the component a is an ethylene/alpha-olefin interpolymer and an ethylene/alpha-olefin multiblock interpolymer.

13. The composition of claim 12, wherein the ethylene/alpha-olefin multiblock interpolymer is an ethylene/alpha-olefin multiblock copolymer.

14. The composition of claim 12, wherein the ethylene/alpha-olefin interpolymer is an ethylene/alpha-olefin copolymer.

15. The composition of claim 12, wherein the weight ratio of the ethylene/alpha-olefin interpolymer to the ethylene/alpha-olefin multiblock interpolymer is from 0.80 to 3.0.

16. The composition of claim 1, wherein the tackifier (component b) is selected from a hydrogenated aliphatic resin, a cycloaliphatic hydrocarbon resin, an aliphatic C5 resin, an aromatic modified aliphatic C5 tackifier, or any combination thereof.

17. The composition of claim 1, wherein the composition comprises from 60 wt % to 100 wt % of the sum of components a and b, based on the weight of the composition.

18. The composition of claim 1, wherein the composition further comprises at least one filler (component c).

19. An article comprising at least one component formed from the composition of claim 1.

20. A method of forming artificial leather, said method comprising mixing the composition of claim 1.
